(19) United States
(12) Patent Application Publication
(10) Pub. No.: US 2024/0285986 A1
(43) Pub. Date: Aug. 29, 2024

(54) Systems and Methods for Tracking Lifeline Payout and Retraction

(71) Applicant: MSA Technology, LLC, Cranberry Township, PA (US)

(72) Inventors: Michael Goodspeed, Pittsburgh, PA (US); Matthew Frederick Jacob, Pittsburgh, PA (US); David Dressner, Cranberry Township, PA (US)

(21) Appl. No.: 18/584,323

(22) Filed: Feb. 22, 2024

Related U.S. Application Data
(60) Provisional application No. 63/486,530, filed on Feb. 23, 2023.

(51) Int. Cl. A62B 35/00

(52) U.S. Cl. CPC A62B 35/0025; A62B 35/0043

(57) ABSTRACT

Systems and methods are provided for a fall limiting device. A fall limiting device includes a fall arrest mechanism configured to control a lifeline extending therefrom, said control comprising one or more of: paying out the lifeline, retracting the lifeline, and brake events indicating a fall arrest condition. A sensor system is configured to monitor one or more aspects of said control of the lifeline and to record data on a non-transitory computer-readable medium. A data output system is configured to provide access to the recorded data.

### CROSS-REFERENCE TO RELATED APPLICATIONS

This application claims priority to U.S. Provisional Application No. 63/486,530, filed Feb. 23, 2023, which is incorporated herein by reference in its entirety.

### BACKGROUND

In height safety applications, such as, for example, working on a building roof, it is common for a fall limiting device, such as a self-retracting lanyard (SRL), to be provided for connection to a structure or a safety line. In normal operation, the fall limiting device allows a lifeline to be output from the fall limiting device to allow the user some freedom of movement. In the event of a fall, the fall limiting device may include mechanisms for arresting the fall while maintaining the integrity of the fall limiting device and lifeline so as to avoid or limit injury.

### SUMMARY

Systems and methods are provided for a fall limiting device. A fall limiting device may include a fall arrest mechanism configured to control a lifeline extending therefrom, said control comprising one or more of: paying out the lifeline, retracting the lifeline, and brake events indicating a fall arrest condition. A sensor system is configured to monitor one or more aspects of said control of the lifeline and to record data on a non-transitory computer-readable medium. A data output system is configured to provide access to the recorded data.

In another example, a method of operating a fall limiting device includes providing a fall arrest mechanism configured to control a lifeline extending therefrom, said control comprising one or more of: paying out the lifeline, retracting the lifeline, and brake events indicating a fall arrest condition. One or more aspects of said control of the lifeline are monitored using a sensor system. Data from the sensor system is recorded on a non-transitory computer-readable medium, and the recorded data is transmitted from the fall limiting device.

### BRIEF DESCRIPTION OF DRAWINGS

FIG. 1 is a diagram depicting a safety line system securing a person performing construction operations at the top of a structure.

FIG. 2 depicts one embodiment of a fall limiting device.

FIG. 3A is a diagram depicting a fall limiting device operating in a first, normal operating condition.

FIG. 3B is a diagram depicting a fall limiting device during a second, fall operating condition.

FIG. 4 illustrates an unwinding-speed limit control in stowed position attached to a rotatable drum.

FIG. 5 provides an alternate view of the fall limiting device that depicts the lifeline extending from within the housing to the exterior through an aperture,

FIG. 6 depicts a fall limiting device, including a retraction dampener subassembly, having lifeline extending therefrom.

FIG. 7 depicts a sensor system monitoring a retraction dampener subassembly gear interacting with a lifeline drum gear.

FIG. 8 is a graph illustrating an example translation of detected rotations of a retraction dampener gear to an amount of lifeline paid out and/or retracted into the fall limiting device.

FIG. 9 is a diagram depicting an example embodiment where a rechargeable battery is charged using energy associated with the paying out or retracting of the lifeline.

FIG. 10 is a diagram illustrating wireless transmission of data from a fall limiting device to a hub.

FIG. 11 depicts a rotary encoder configured to sense rotation of a lifeline hub.

FIG. 12 depicts three examples of configurations for detecting rotation via inductance.

FIG. 13 depicts a fall limiting device equipped with an optical sensor.

FIG. 14 depicts indicia incorporated into or onto a lifeline to facilitate monitoring of pay out or retraction.

FIG. 15 is a diagram depicting triangulation of a location of a fall limiting device based on an tag affixed to the device.

FIG. 16 depicts a gearbox with a rotary counter that is incorporated into a fall limiting device.

FIG. 17 depicts another mechanical apparatus for measuring an amount of lifeline paid out from a fall limiting device or a number of times that lifeline has been paid out from the fall limiting device.

FIG. 18 depicts a further mechanical mechanism for measuring payout and retraction of a lifeline from a fall limiting device or a number of times that lifeline has been paid out from the fall limiting device.

FIG. 19 provides a further mechanical mechanism for measuring lifeline payout and retraction via a sacrificial nozzle.

FIG. 20 is a diagram depicting an example fall limiting device.

FIG. 21 is a flow diagram depicting a method of operating a fall limiting device.

FIG. 22 depicts a magnetic encoder configured to sense rotation of a lifeline hub.

FIG. 23 depicts a capacitive encoder configured to sense rotation of a lifeline hub.

FIG. 24 depicts a optical encoder configured to sense rotation of a lifeline hub.

### DETAILED DESCRIPTION

System and methods as described herein provide techniques for allowing a fall limiting device to output (pay out) a portion of the lifeline associated with the fall limiting device from its housing during normal operation to allow a connected user some freedom of movement while retaining a portion of the lifeline within the housing. In embodiments, the fall limiting device utilizes a fall arrest mechanism that is activated based on motion of the lifeline. Systems and methods herein include a sensor system comprising one or more sensors that monitor operation of the fall arrest mechanism (e.g., paying out, retracting, applying a braking force to the lifeline, the occurrence of a brake event). Sensor data is recorded in a non-transitory computer readable medium for subsequent analysis. For example, that data may be used to indicate when the fall limiting device should be inspected, have maintenance procedures be performed on it, or be retired from further use. Such activities may be called for when the fall limiting device has been used more than a threshold amount (e.g., a threshold amount of line is paid out/retracted, a threshold number of times the line has been paid out/retracted, a threshold period of time, a threshold number (e.g., 1, 2) brake events (e.g., brake deployments, applications of a breaking force to the lifeline)). The stored data may be transmitted from the fall limiting device (e.g., via a wireless or wired connection) for analysis and determination by an outside computing device (e.g., a mobile device, an external server). That data may be transmitted on demand as instructed by an outside device to which the fall limiting device is paired. Transmission may also be periodic, where the fall limiting device periodically (e.g., daily, hourly, weekly, on occurrence of an event, when a memory therein is full or near full) transmits recorded data for acquisition by any listening device.

In other instances, the stored data may be analyzed by a data processor on the fall limiting device to produce an indication (e.g., a maintenance needed indication) at or on the fall limiting device, such as via an indicator light or mechanical indicator. In some embodiments, wireless data transmission capabilities of the fall limiting device may be configured to transmit data indicative of an emergency condition, such as when a fall is detected, initiating emergency response procedures such as sending help and indicating that the fall limiting device should not be further used (e.g., until it is inspected, refurbished). In one example, a fall arrest condition may be sensed when rotation of a drum or other rotating structure exceeds a predetermined threshold followed by no rotation for a threshold duration. Other fall arrest condition indicators may include accelerometer data provided by sensor hardware incorporated into the fall limiting device or sensed deployment of a brake mechanism.

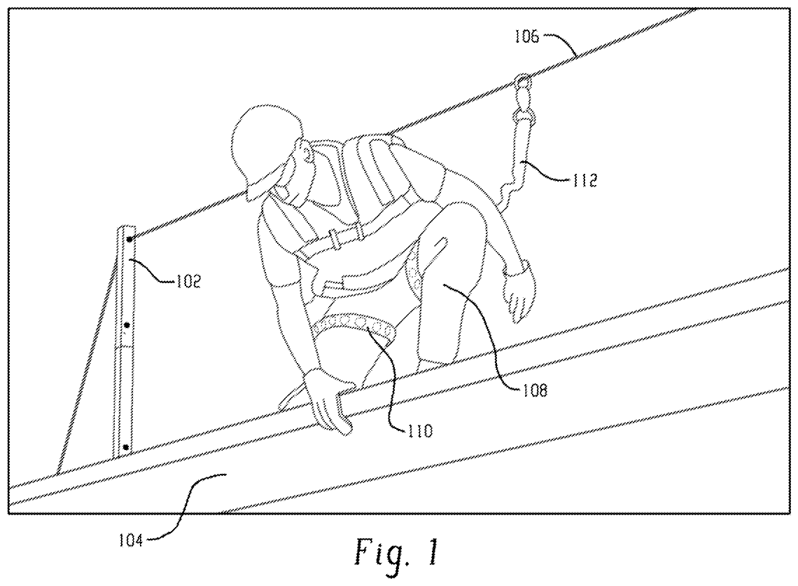

FIG. 1 is a diagram depicting a lifeline system securing a person performing construction operations at the top of a structure. The system includes a first rigid member 102 that takes the form of a vertical post extending from a horizontal component 104 of the structure. The first rigid member 102 may be connected to the horizontal component 104 via mechanical means such as bolts, screws, adhesive, or otherwise. A lifeline 106 is connected to the first rigid member 102 and runs horizontally between the first rigid member 102 and a second rigid member (not shown). An operative 108, in the form of a user person performing construction operations, wears a harness 110 via which the user 108 is connected to the lifeline 106 via a tether 112. The lifeline arrangement of FIG. 1 enables the user 108 to traverse the structure, anywhere within a tether length of the lifeline. The tether 112 is connected to a fall limiting device (not visible in FIG. 1) which is further connected to the harness 110 of the user 108. In accordance with embodiments herein, the fall limiting device is configured to pay some of the lifeline during normal operation to allow the user 108 some freedom of movement. The fall limiting device may further be configured to retract some of the lifeline based on movement of the user 108 closer to the connection point. The fall limiting device is further configured to apply a breaking force to the lifeline during a fall condition. The fall limiting device includes a sensor system configured to monitor one or more aspects of the fall limiting device's control of the lifeline. Tracked metrics may take a variety of forms including a “mileage” indicating a length of lifeline paid out or retracted into the fall limiting device. That mileage may be augmented based on additional metrics such as total drum rotations, total time in the field, temperature, humidity. Other metrics may include a minimum, maximum, and average length of lifeline paid out during active use, and a number of indications of a fall event.

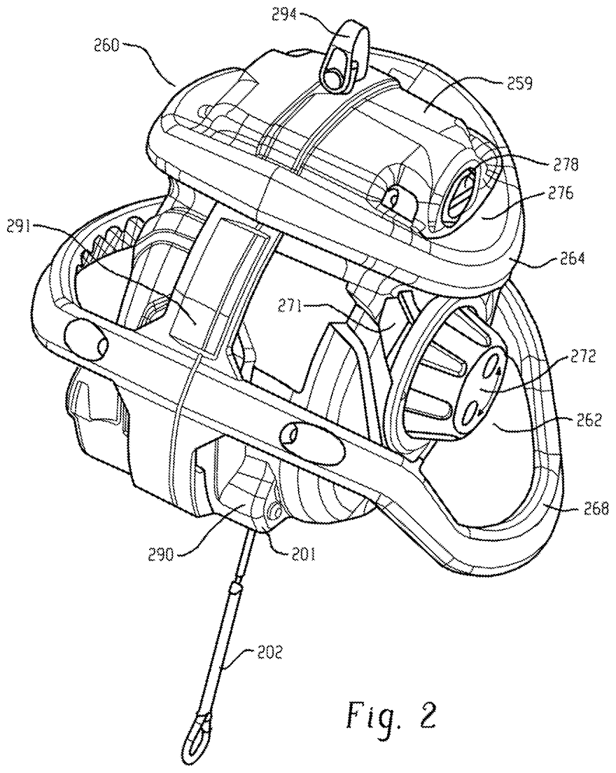

FIG. 2 depicts one embodiment of a fall limiting device configured to sit on a supporting surface such as a platform or a roof. The fall limiting device 260 includes a rollable, protective shell comprising a case 259, a first contact surface ring 264 which is integral to the case 259, and a second contact surface ring 268 which is reversibly connected to the case 259 by mechanisms of attachment 291, which, in the present example, use bolts or screws. The case 259 further comprises a connector 294 for securing the case 259 to an anchor (not shown). The case 259 further comprises a cable outlet 201 through which the cable 202 of the fall limiting device 260 may extend. In FIG. 2, the cable outlet 201 is positioned at one end of the fall limiting device 260, which, in combination with the tension imposed on the cable 202 by the fall limiting device 260 and the user (not shown), causes the fall limiting device 260 to rotate such that the cable 202 is in an elevated position relative to a rest surface (e.g., the ground) on which the safety device sits.

The first contact surface ring 264, second contact surface ring 268, and case 259 of the rollable, protective shell provide a first aperture 262 through which a first actuator 272 of the fall limiting device 260 encased therein may be accessible to manipulation by a user. Optionally, the first contact surface ring 264 together with the case 259 of the shell provide a second aperture 276 through which a second actuator 278 of the fall limiting device 260 encased therein may be accessible to manipulation by a user. The first actuator 272 may provide a mechanism for adjusting any aspect of the function of the fall limiting device 260. For example, in some embodiments, the first actuator 272 is a dial to set the length of cable 202 that may be paid out from the fall limiting device 260. The second actuator 278 may be of any type to adjust any aspect of the function of the fall limiting device 260. For example, in some embodiments, the second actuator 278 controls whether or not the cable 202 is able to be paid out or not. Optionally, the case 259 may comprise a window 271 to display a setting of an actuator of the fall limiting device 260, e.g., a device maintenance indicator, a setting associated with the first actuator 272. The fall limiting device 260 may include a retraction dampener 290 that is configured to slow retraction of the lifeline 202 into the fall limiting device 260. In one embodiment, the retraction dampener 290 comprises a gear that interacts with a drum around which the lifeline is wound via a one way gear or a sprag clutch, wherein the retraction dampener gear applies a counterforce to a retraction force applied by the drum when the drum and the retraction dampener gear are turning in a direction associated with retraction of the lifeline 202 (e.g., brake shoes are pushed against a surface based on turning of the retraction dampener subassembly at more than a threshold rotation rate).

In embodiments, the fall limiting device 260 includes a sensor system configured to monitor one or more aspects of the fall limiting device's control of the lifeline 202. In one example, one or more sensors are positioned on or within the fall limiting device 260 such as near the cable outlet 201 to monitor paying out of the lifeline 202, retraction of the lifeline 202, and the occurrence of a brake event during a fall arrest condition. Sensor data may be transmitted from the fall limiting device 260, such as via wireless data communication. In some examples, the sensor data may be used to provide information at window 271 regarding use and maintenance status of the fall limiting device 260. That information at 271 may take the form of an odometer reading (e.g., an amount of lifeline 202 paid out or retracted in since last maintenance) or a maintenance indicator (e.g., green-device in good working order, yellow-maintenance needed soon, red-maintenance needed now). A maintenance indicator may be informed by the recorded sensor data. In one instance a yellow or red indication may be provided based on a length of lifeline 202 paid out since last maintenance was recorded. In an embodiment, a red indication may also be shown when one or more fall arrest conditions is detected at the fall limiting device 260. The fall limiting device 260 may include a mechanism for resetting the state of the device (e.g., resetting an odometer, resetting a fall arrest condition count) when maintenance is performed. In embodiments, the resetting mechanism may be difficult or impossible for a user to perform without a particular maintenance tool, a password, or other solution to a tamper protection mechanism.

In some examples, the sensor data may be used to lock the fall limiting device 260 from further use until certain action is taken. For example, a fall limiting device 260 may be configured to inhibit rotation of a lifeline hub or other rotating structure when maintenance of the fall limiting device 260 is required. Such locking may also be initiated by a signal received from a remote location (e.g., from a server monitoring usage data, from a server that has received an indication that the fall limiting device 260 is being incorrectly used or has been stolen). Sensor data may be captured and stored for its use in maintenance tracking as well as for general usage analysis, including usage compliance analysis. The lifeline pay out data may be used alone or in conjunction with other data, such as inertial measurement unit (IMU) data, GPS data, or accelerometer data from sensors positioned on the fall limiting device 260 to provide information regarding usage of the fall limiting device 260.

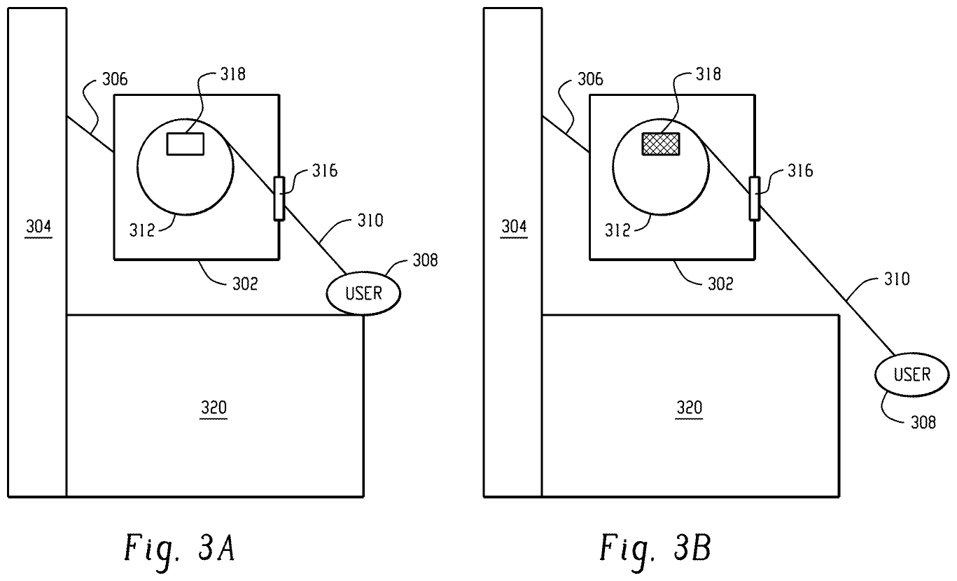

FIG. 3A is a diagram depicting a fall limiting device operating in a first, normal operating condition. A fall limiting device 302 is connected to a first structure 304 via connection 306. That connection 306 may take a variety of forms including a line from the fall limiting device 302 to the first structure 304 connected directly or indirectly using a connection device(s), such as hooks, clips, loops, carabiners. The connection 306 may also be direct using connection devices, such as a carabiner connected to the fall limiting device 302 being clipped to a loop or hook attached to the first structure 304. The first structure 304 may take a variety of forms including a wall, a line (e.g., as depicted in FIG. 1), a horizontal (e.g., floor) structure, and a sloping roof. A user 308 is also connected to the fall limiting device 302 via a lifeline 310 having a portion of its length wrapped around a lifeline drum 312 inside a housing of the fall limiting device 302. In an example, the user 308 is connected to the lifeline 310 of the fall limiting device 302 via a connection device such as a hook, clip, loop, or carabiner when working on horizontal second structure 320 in the vicinity of where the fall limiting device 302 is connected to the first structure 304 via 306. In embodiments, the user 308 may clip out of and into lifelines of different fall limiting devices as the user 308 moves around a work site. The lifeline 310 may take a variety of forms including a single metal line, a braided metal line, a single synthetic material line, a synthetic material line made from multiple strands, a natural material line made of strands.

In a first, normal operation, such as when the user 308 is safely working on second structure 320, the fall limiting device 302 allows a portion of the lifeline 310 to be paid out from the housing of the fall limiting device 302 to provide the user 308 some freedom of movement. In a fall limiting device 302 that takes the form of a self-retracting lanyard, the lifeline drum 312 therein may be biased by a spring or other mechanism that retracts the paid out lifeline 310 when not under tension by the current location of the user 308.

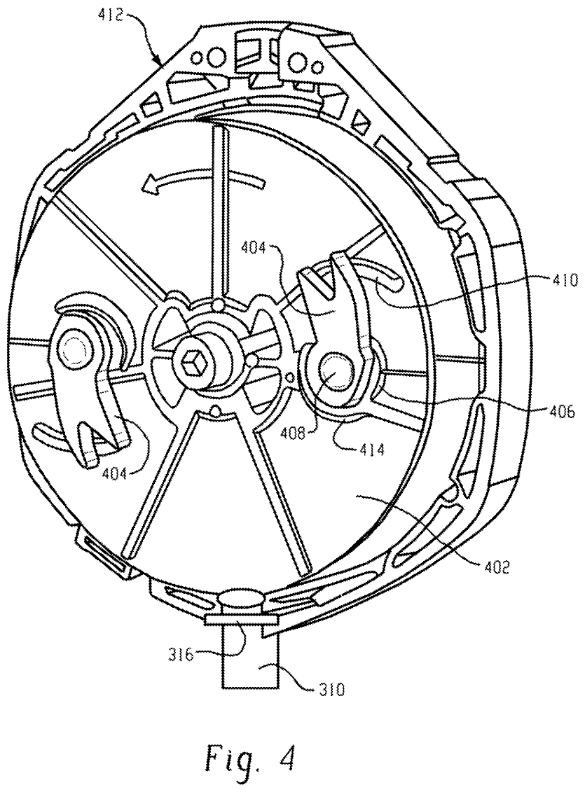

The fall limiting device 302 further includes a fall arrest mechanism (shown further with reference to FIG. 4), which in FIG. 3A is in the disengaged state. The fall arrest mechanism acts alone or in combination with other fall arrest mechanisms (e.g., inline energy absorbers connected between the lifeline 310 and the user 308, between the fall limiting device 302 and the first structure 304) to halt and mitigate damage from a user fall. In embodiments, the fall arrest mechanism is deployed based on motion (e.g., acceleration, force initiated by fast payout) of the lifeline 310. In certain examples, the fall arrest mechanism is attached to the lifeline drum 312 and is deployed based on forces experienced when the lifeline drum 312 rotates at more than a threshold rate. For example, and as described further herein, the fall arrest mechanism may include one or more pawls that rotate from a stowed position to an engaged position based on force provided by rotation of the lifeline drum 312 when the lifeline 310 is paid out at a high rate of speed, such as during a fall condition.

A sensor system 316 may be provided to monitor one or more aspects of control of the lifeline 310, such as paying out and retracting of the lifeline 310 by the lifeline drum 312 and the occurrence of brake events (e.g., application of a braking force to the lifeline by the fall arrest mechanism). The sensor system 316 may monitor one or more aspects of control of the lifeline 310 and to record data on a non-transitory computer-readable medium. A status indicator 318 provided on the fall limiting device is configured to display an indication of whether the fall limiting device is in a maintenance-needed state based on the recorded data. As noted above, a status indicator 318 may indicate maintenance should be performed, for example, when more than a threshold length of lifeline has been paid out of the device or when more than a threshold number of fall arrest conditions have been detected at the fall limiting device since last maintenance.

For example, in some embodiments, the sensor system 316 may monitor rotation of a gear or a drum around which the lifeline is wound. The sensor system may detect a fall arrest condition and/or record metrics based on the rotation of the gear. A fall arrest condition may be sensed when rotation of a drum or other rotating structure exceeds a predetermined threshold followed by no rotation for a threshold duration. Metrics recorded based on the rotation of a gear or a drum may be “mileage” (i.e., the more of rotations the lifeline as paid out or retracted in its lifetime) as well as minimum, maximum, and average number of rotations during active use.

FIG. 3B is a diagram depicting a fall limiting device 302 during a second, fall operating condition. In the example of FIG. 3B, the user 308 remains connected, via lifeline 310 to the fall limiting device 302, which is further connected to first structure 304 via connection 306. In the example of FIG. 3B, the user 308 has fallen from horizontal structure 320, which transitions the fall limiting device 302 from a normal, first operating condition, to a second, fall arrest condition (e.g., a fall condition, an abnormal condition, an alarm condition, an alert condition, an emergency condition). As illustrated in FIG. 3B, in the second, fall condition, payout of the lifeline 310 has been halted such that the user 308 is held above the ground despite not being supported by the second structure 320. As described above and further below, paying out of the lifeline 310 (e.g., at a fast rate) during a fall condition results in the fall arrest mechanism to be engaged (e.g., based on acceleration forces experienced, based on fast turning of the lifeline drum 312 while the retained portion of the lifeline 310 is unwound during the second, fall condition) to provide a braking force on the lifeline 310. Engaging of the fall arrest mechanism can provide fall mitigation and injury prevention. In embodiments, the fall limiting device 302 entering the second, fall condition may be detected by the sensor system 316 and result in an alarm condition where an audible alarm from the fall limiting device 302 is emitted or a signal is transmitted from an antenna on the fall limiting device 302 (e.g., to a server that tracks operation data (e.g., to monitor safety protocol compliance), alerts authorities of an alarm condition to initiate sending of help). Such an alarm may be initiated based on activation of a switch (e.g., a switch that is triggered when a sensor detects deployment of the fall arrest mechanism). Indicator 318 may change states upon detection of a fall arrest condition, as depicted in FIG. 3B, where a revised indicator 318 communicates that the fall limiting device should undergo maintenance based on detection of the fall arrest condition.

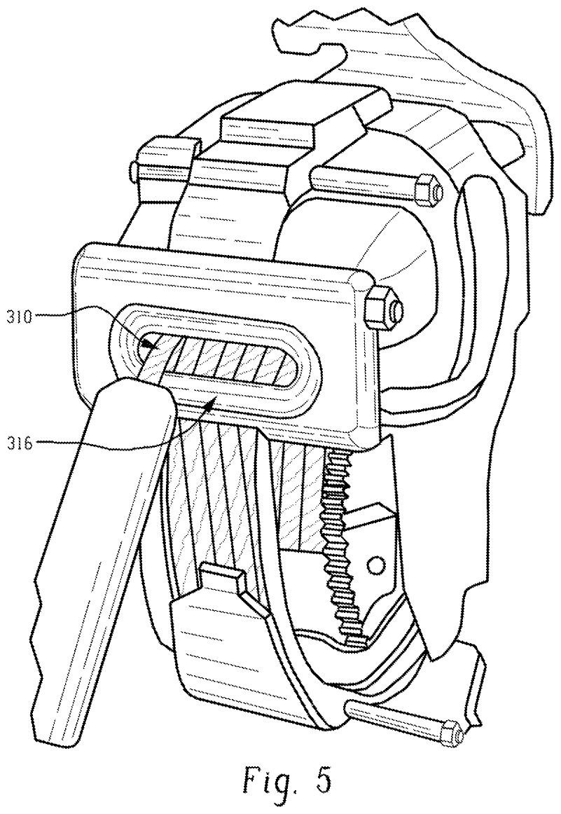

A fall arrest mechanism of a fall limiting device is configured to control a lifeline extending therefrom, where that control may include one or more of paying out the lifeline, retracting the lifeline, and applying a breaking force to the lifeline during a fall arrest condition. A fall arrest mechanism may take a variety of forms. FIG. 4 is a diagram one such example, illustrating an unwinding-speed limit control in stowed position attached to a rotatable drum. The outer surface of one of the side portions 402 of the rotatable drum includes structure for retaining the unwinding-speed limit control, which in the example of FIG. 4 includes a spring-biased pawl 404. In the example of FIG. 4, the structure includes a disc-shaped platform 406 on which the pawl 404 sits and a post 408 about which the pawl 404 rotates. In embodiments, the post 408 may be wider at its outward end to aid in retention of the pawl 404, enabling the pawl 404 to be snapped into place. A first, curved guide rail 410 facilitates rotation of the pawl 404 from its stowed position, shown in FIG. 4, to its deployed position via clockwise rotation, where in the deployed position the teeth of the pawl 404 interact with structure of the housing 412 to arrest deployment of the retractable lifeline 310 from the fall limiting device 202. The structure for retaining the pawl 404 further includes a second, curved guide structure 414. That structure 414, in embodiments, may serve multiple purposes. First, that structure 414 may aid in retaining the pawl 404 on the post 408 and may limit counter-clockwise rotation of the pawl 404 to beyond its stowed position. Further, structure 414 may include a structure for interfacing with a spring (not shown). The spring may be positioned between that surface and a surface on the underside of the pawl 404 so as to bias the pawl 404 toward the depicted stowed position when subjected to force less than the counter-force provided by the spring. Rotation of the drum at faster than a threshold rate (e.g., during the second, fall condition) induces a force greater than the spring force, which extends the pawls 404 to an engaged position. Thus, the fall arrest mechanism will engage any time a fall condition occurs. A sensor system 316 is positioned at a point where the lifeline 310 is output from the fall limiting device. The sensor system 316 is configured to monitor control of the lifeline 310, such as payout of the lifeline 310, retracting the lifeline 310, and the occurrence of a brake event (e.g., application of a braking force to the lifeline via pawls 404) during a fall arrest condition. In one embodiment, a sensor is provided at or near one or more of the pawls 404 to detect when the pawl is extended into an engaged position. In another example, a sensor 316 monitors acceleration of the lifeline 310, where a sudden acceleration or deceleration in a particular detection may indicate that a fall arrest condition has occurred. FIG. 5 provides an alternate view of the fall limiting device that depicts the lifeline 310 extending from within the housing to the exterior through an aperture, where a sensor system 316 may be positioned at or near the aperture so as to monitor one or more aspects of a fall arrest mechanism controlling the lifeline 310.

Additional details regarding this fall arrest mechanism may be found in U.S. patent application Ser. No. 17/710,365, filed Mar. 31, 2022, the entirety of which is herein incorporated by reference. Additional examples of fall arrest mechanisms, including those that utilize a tolerance ring as a component in applying a braking force to the lifeline based on motion of the lifeline are provided in U.S. Pat. No. 9,670,980, filed Apr. 18, 2014, the entirety of which is herein incorporated by reference.

A sensor system as described herein may take a variety of forms. In one example, a sensor system is configured to be retrofit into the retraction dampener subassembly of a fall limiting device. As noted above is discussing FIG. 2, a retraction dampener provides a force that slows retraction of the lifeline into the fall limiting device. The retraction dampener may be provided as a module near the point in the fall limiting device where the lifeline is output from the device. In embodiments, a replacement module may still provide retraction dampening functionality, where a sensor system is added to retraction dampening hardware that functions similarly to the retraction dampener subassembly being replaced. In other examples, certain retraction dampening functionality may not be replicated in the replacement module, such as in favor of sensor system hardware. In one such example, a retraction dampener gear may be retained in a replacement module and used by the sensor system to monitor control of the lifeline, but where hardware for applying a counterforce for slowing retraction of the lifeline may be limited omitted from the replacement module.

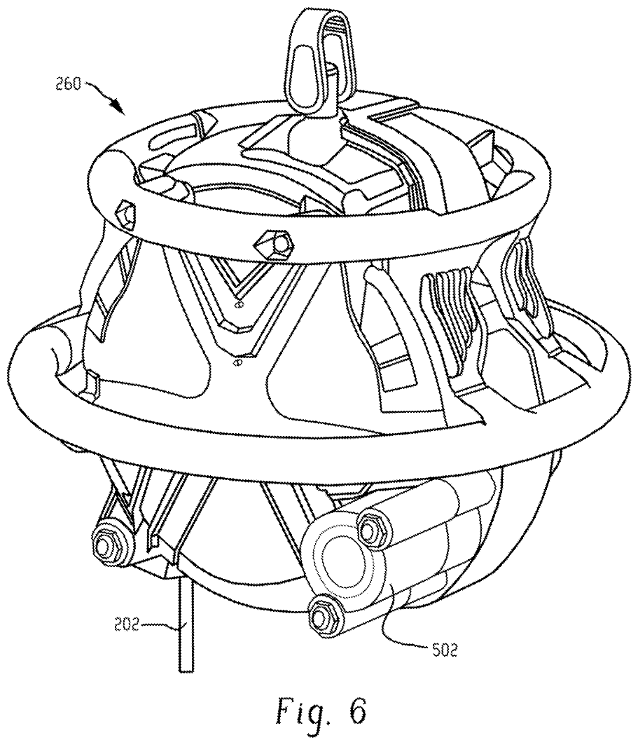

FIG. 6 depicts a fall limiting device, including a retraction dampener subassembly, having lifeline 202 extending therefrom. In the example of FIG. 6, a sensor enabled retraction dampener subassembly 502 is incorporated into the fall limiting device 260. The subassembly 502 may be connected to the device 260 at the time of manufacture, or the subassembly 502 may be retrofit onto an existing fall limiting device, such as to increase the capabilities of the fall limiting device. The subassembly 502 may be equipped with sensors to monitor paying out of the lifeline 220, retracting the lifeline 220, and the occurrence of brake events (e.g., during a fall arrest condition). That monitoring may be performed in a variety of ways, such as those described herein. For example, a sensor system may monitor turning of the retraction dampener subassembly 502 gear so as to approximate the length of the lifeline 220 from the fall limiting device (e.g., based on a size relationship between the retraction dampener gear relative to a corresponding gear associated with the drum around which the lifeline 220 is wrapped within the fall limiting device 260). The retraction dampener subassembly 502 may be equipped with sensors, memory, batteries (e.g., rechargeable batteries responsive to energy converted from turning of the retraction dampener gear), and communications hardware for sensing control of the lifeline, storing recorded data on a non-transitory computer-readable medium, and communication of recorded data from the fall limiting device 260, such as via a wireless communication protocol (e.g., Wi-Fi connection to a wireless router, Bluetooth connection to a mobile device, other near field communication protocol). In one embodiment, the sensor-equipped retraction dampener subassembly 502 is plug and play, such that it can communicate a device identifier and recorded data with an outside device substantially immediately upon installation.

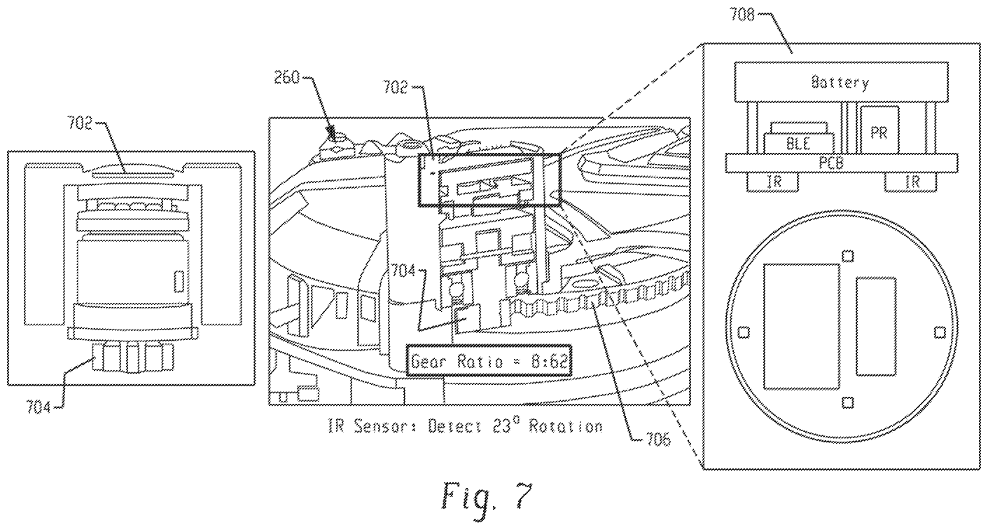

As noted above, an amount of lifeline paid out or retracted from a fall limiting device may be ascertained by a sensor monitoring turning of a retraction dampener gear. FIG. 7 depicts a sensor system monitoring a retraction dampener subassembly gear interacting with a lifeline drum gear. In FIG. 7, a retraction dampener subassembly 702 includes a gear 704 extending therefrom. The retraction dampener gear 704 interacts with teeth 706 of a gear associated with the drum around which the lifeline is wound when within the fall limiting device 260. In the example of FIG. 7, the relative gear ratio between the retraction dampener gear 704 and the drum gear 706 is 8:62. The retraction dampener subassembly 702 includes electronics 708 of a sensor system that are configured to monitor one or more aspects of control of the lifeline, such as payout or retraction of the lifeline from the fall limiting device 260. In the example of FIG. 7, the electronics 708 monitor turning of the sensor retraction subassembly gear to approximate the length of lifeline paid out from the fall limiting device 260. The electronics include printed circuit board (PCB) that is responsive to a battery for powering components thereon. A Bluetooth Low Energy (BLE) antenna is mounted onto the printed circuit board for communication with a paired device such as a mobile device or mobile phone with an application (app) configured for interfacing with the electronics 708. A processor (PR) commands two infrared sensors (IR) to detect changes to the position of the retraction damper subassembly gear 704 to determine its amount of rotation. The processor (PR) records that data in a non-transitory computer-readable medium and/or commands its transition from the subassembly 702 via the BLE antenna. The transmitted data may be associated with an amount of detected rotation of the gear 704 or velocity or acceleration associated with gear 704. In one embodiment, the processor (PR) is configured to convert an amount of detected rotation of the subassembly gear 704 to an estimated amount of lifeline payout from the fall limiting device 260 based on the gear ratio relative to the gear associated with the drum around which the lifeline is wound. The electronics 708 may be encased in a waterproof or water resistant enclosure such that the fall limiting device may be used in an environment where water is present without damaging the electronic 708.

Pairing between a fall limiting device and an external computing device may be performed in a variety of ways. In one example, when a fall limiting device is desired to be paired (e.g., when it is first put into use, when a sensor module is retrofitted onto the fall limiting device, when a new external computing device is sought to be used), an application on the external computing device is initiated. Near field communications responsive to the application may be used to scan an RFID tag on the fall limiting device. The RFID tag responds with an identifier (e.g., an ID number) associated with the fall limiting device. The external computing device may further communicate with a processor positioned in the fall limiting device to extract an identifier (e.g., via a second RFID tag) associated with the sensor system electronics therein. The application can then associate data received from the processor with the RFID identifier to correlate data received from the electronics with the particular fall limiting device having the RFID tag thereon.

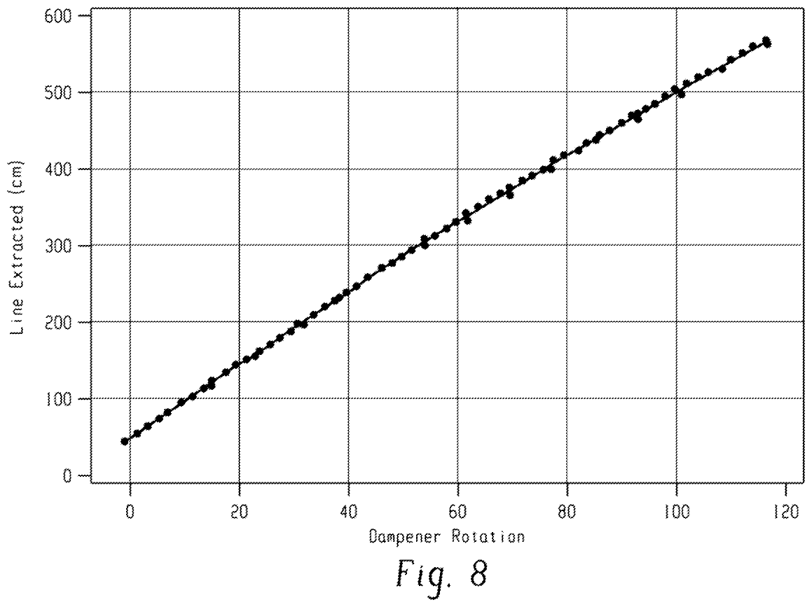

FIG. 8 is a graph illustrating an example translation of detected rotations of a retraction dampener gear to an amount of lifeline paid out and/or retracted into the fall limiting device. In an embodiment, detected rotations of the dampener gear in paying out or retracting the lifeline are converted to a length of lifeline retracted based on the gear ratio and/or other factors such as gear diameter, drum diameter, drum hub circumference). While maintenance, retirement, or other fall limiting device decision making could, in some embodiments, be made based on thresholds associated with the retraction dampener gear rotations directly, length of line paid out or retracted may provide a more intuitive metric for evaluating when maintenance should be performed. Length of lifeline paid out or retracted may also provide a metric that can be applied and evaluated across devices, where the mechanism for monitoring lifeline control (e.g., detection of rotation of the lifeline drum, detecting rotation of the retraction dampening gear, detecting movement of the lifeline) may vary across fall limiting devices, including using certain of the different techniques described herein.

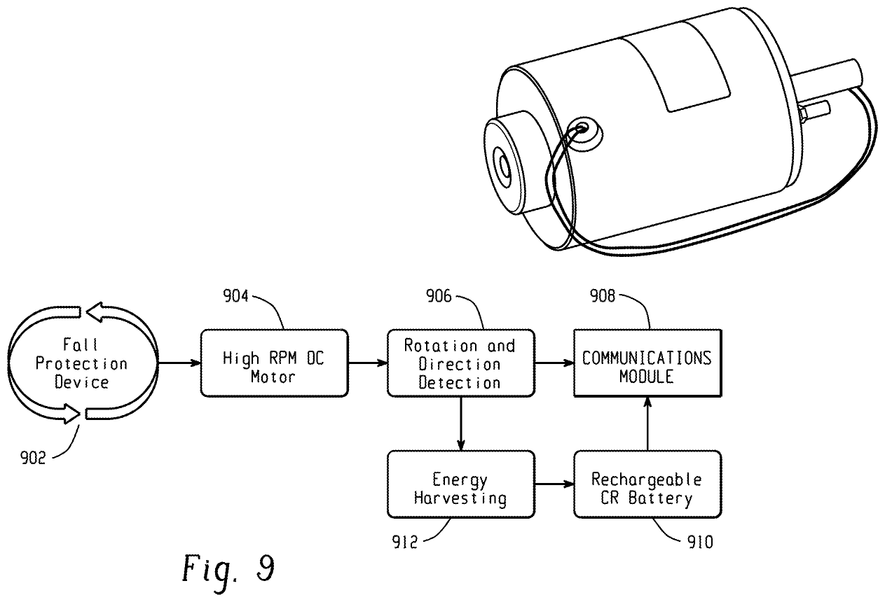

As illustrated in FIG. 7, certain electronics associated with a sensor system and a communication module for transmitting data therefrom may be battery powered. In some instances, a battery may be replaced when it runs low in power. To facilitate an implementation where less maintenance is required, a rechargeable battery is used. FIG. 9 is a diagram depicting an example embodiment where a rechargeable battery is charged using energy associated with the paying out or retracting of the lifeline. Alternatively, the rechargeable battery is charged using solar power, for example, via a solar panel or solar cell (not shown). A fall protection or fall limiting device 902 pays out and retracts lifeline to safeguard a user connected thereto. A high RPM DC motor 904 is connected thereto, such as to a gear in the fall limiting device, such as a hub gear or a gear of the retraction dampening subassembly. A sensor system 906 measures rotation of the motor 904 (e.g., direction and amount) so as to record data regarding the paying out and retraction of lifeline from the fall limiting device. In one embodiment, a back EMF signal generated by the DC motor is used to evaluate rotations/rotational speed of the hub, thereby defining lifeline pay out and retraction.

The sensor system 906 is responsive to a communications module 908 that, in the embodiment of FIG. 9, includes an RF Solutions 915 MHz LoRa transmit/receive module. That module 908 is configured to wireless pair with an external entity and to transmit data (e.g., an identifier value associated with the fall limiting device and recorded sensor data) from the fall limiting device. The sensor system 906 and the transmit/receive module 908 are powered by a rechargeable battery 910. The rechargeable battery 910 is charged based on energy harvested at 912, transferring energy from the turning of the motor 904 to the battery 910 for storage. In this way, use of the fall limiting device can enable increasing the length of time that its use and status may be monitored.

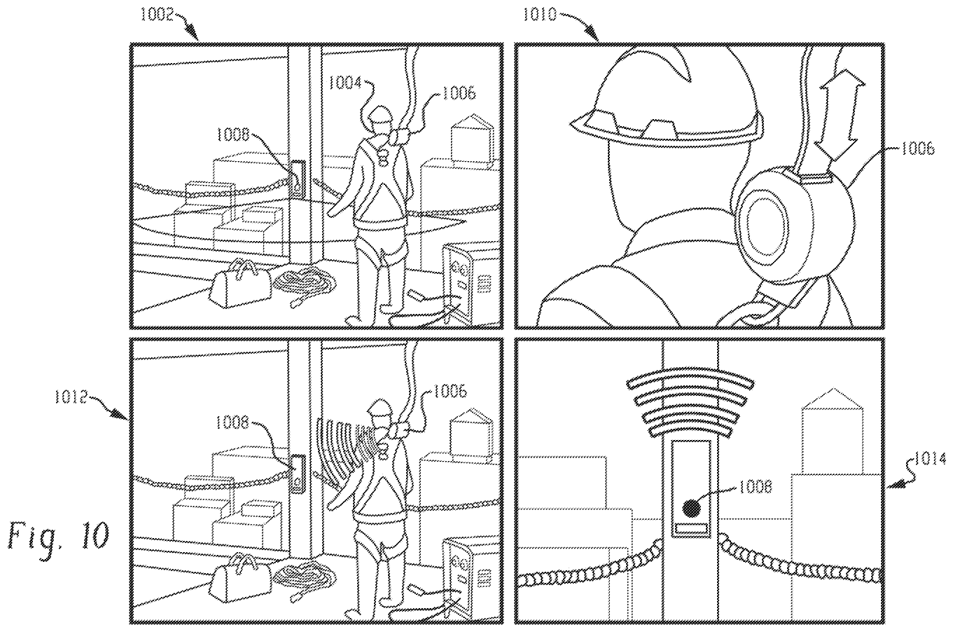

A fall limiting device may be configured to output data in a variety of ways. As noted above, a fall limiting device may be configured to display information based on recorded sensor data using a display panel (e.g., LED or LCD screen, status lights) thereon. A device may be configured to communicate data via a physical connection, such as a USB port or a portable memory device (e.g., an SD card, a USB thumb drive). In other embodiments, the fall limiting device is configured to transmit data wirelessly. FIG. 10 is a diagram illustrating wireless transmission of data from a fall limiting device to a hub. Panel 1002 displays a user 1004 working on a platform near a drop off. The user 1004 is connected to a supporting structure by a fall limiting device 1006. The fall limiting device 1006 is configured to monitor control of a lifeline to which the user 1004 is connected. The device 1006 may be configured to monitor an amount of lifeline paid out from the device 1006, retracted back into the device 1006, or the occurrence of brake events, such as where a brake force is applied to the lifeline in a fall condition. A wireless communication device 1008 (e.g., a Wi-Fi router) is present in the work area and communicates with the fall limiting device 1006 (e.g., periodically, when the fall limiting device 1006 broadcasts that a fall arrest condition has occurred). The fall limiting device 1006 transmits data regarding its monitored control of the lifeline to the wireless communication device 1008, where such data may be used to determine when maintenance on the fall limiting device 1006 should be performed or when the fall limiting device should be retired from use. In an embodiment, the fall limiting device 1006 includes a locking mechanism (e.g. a pin that blocks rotation of a gear) that prevents operation of the fall limiting device based on the monitored data (e.g., when maintenance should be performed, after the fall limiting device should be retired from use).

Panel 1010 illustrates the fall limiting device sensing and recording data regarding control of the lifeline by the fall limiting device. Panel 1012 shows the fall limiting device transmitting recorded data or data derived therefrom to the wireless communication device 1008, and panel 1014 illustrates the wireless communication device 1008 wirelessly transmitting data received from the fall limiting device 1006 to another computer entity, such as a server via a network, for storage of that data and analysis. In one embodiment, the server may be configured to identify a service status for fall limiting devices based on usage data received from those fall limiting devices, enabling scheduling of maintenance activities for those fall limiting devices.

In an embodiment, the fall limiting device 1006 may also be responsive to signals received from the wireless communication device 1008. For example, the wireless communication device 1008 may broadcast a signal indicating the type of operating environment in which it is located. In some circumstances, fall limiting devices may be restricted to use in different environments. For example, in some environments where a lifeline could be subject to forces (e.g., cutting forces caused by sharp edges) that could result in compromise of the lifelines, a heavier duty fall limiting device 1006 may be required. A processor of the fall limiting device 1006 may be configured to recognize when it is in an area where its use is inappropriate, based on a signal received from the wireless communication device 1008. The fall limiting device 1006 may be configured to produce an indication thereof (e.g., a displayed warning, a red indicator light). The fall limiting device 1006 may further be configured to prevent its usage in that environment, such as by preventing rotation of a structure within the fall limiting device via activation of an interfering pin. Permissible-use-location-fencing may also be provided by GPS functionality included in the fall limiting device. In some instances, the maximum length of lifeline that can safely be paid out from the fall limiting device 1006 (e.g., based on a height of an associated drop off) may be broadcast from the wireless communication device 1008. A processor at the fall limiting device 1006 may be configured to limit the amount of lifeline that can be paid out at any one time based on that signal from the wireless communication device 1008.

As noted above, a fall limiting device may use a variety of techniques for sensing control of a lifeline extending therefrom, such as the infrared observation of turning of a retraction dampening gear as described above. Other options include capacitive sensing, activation of mechanical buttons, back EMF detection.

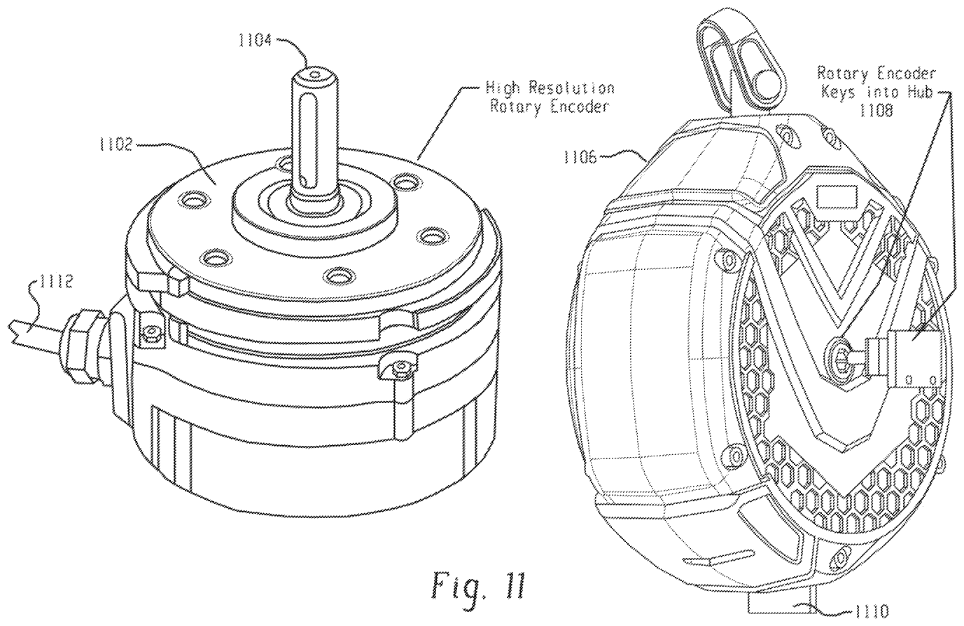

FIG. 11 depicts a rotary encoder configured to sense rotation of a lifeline hub. The rotary encoder 1102 includes a protrusion 1104. That protrusion 1104 may be round or may be of a different shape (e.g., substantially round with a portion removed or added for interfacing with a corresponding hole at the center of a lifeline hub (or other gear or rotating structure) of a fall limiting device 1106. The protrusion 1104 is inserted into the hub as illustrated at 1108 such that the protrusion is rotated as lifeline 1110 is paid out and/or retracted from the fall limiting device. A signal indicating an amount of rotation of the protrusion caused by rotation of the lifeline hub is transmitted (e.g., via a wired medium 1112 or wirelessly) to a processor. That rotation data can be converted to a length of lifeline metric, which may be used to make maintenance decisions regarding the fall limiting device 1106. In embodiments, those maintenance decisions can be made based on the protrusion 1104 rotation sensing directly, without conversion to a length of line paid out/retracted metric. Fast rotation of the protrusion 1104 may also be used to detect a fall arrest condition. In one embodiment, the rotary encoder is an incremental rotary encoder from BEI sensors. In some examples, a signal from the rotary encoder 1102 may be used as an activation signal to wake a sensor system from a sleep mode, where the use of sleep and other low power modes enables increased power efficiency.

In some embodiments, the rotary encoder may output a signal based on a change of position of the gear and/or drum that it is connected to. This signal may be an activation signal to wake the sensor system from sleep mode as described above.

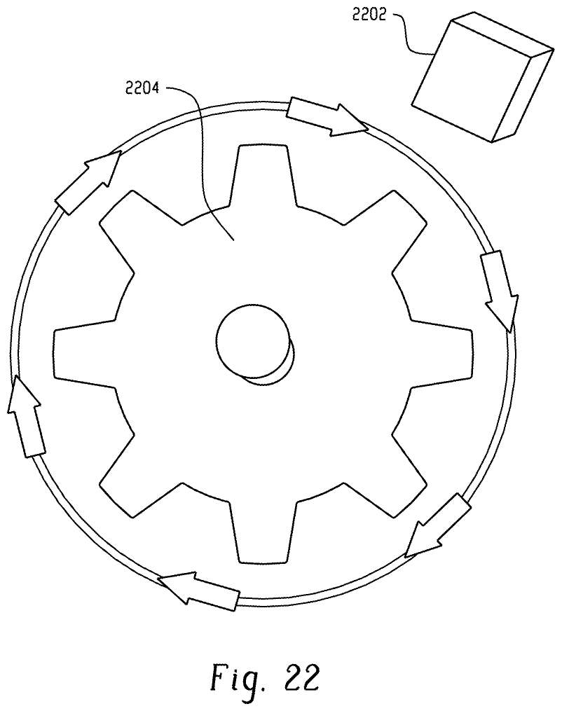

In some embodiments, rotation of a structure, such as the lifeline hub is monitored via magnetic encoders, which is a type of rotary encoder that uses magnetic sensors to detect changes in magnetic fields. FIG. 22 depicts a magnetic encoder 2200. A magnetic sensor 2202 is fixed in the housing of the lifeline hub (not shown). The lifeline is wound around a ferromagnetic gear 2204 with teeth. Thus, when the teeth move past the magnetic sensor, the changing magnetic field generates a voltage pulse. This voltage pulse can be converted to the number of rotations. One variation of magnetic encoder 220 is a hall-effect magnetic encoder. A hall-effect sensor 2202, which comprises of a layer of semiconductor, is connected to a power source (not shown). The hall-effect sensor 2202 detects a magnetic field, and when the gear 2204 rotates, it can detect changes in the magnetic field to monitor rotation of the lifeline hub.

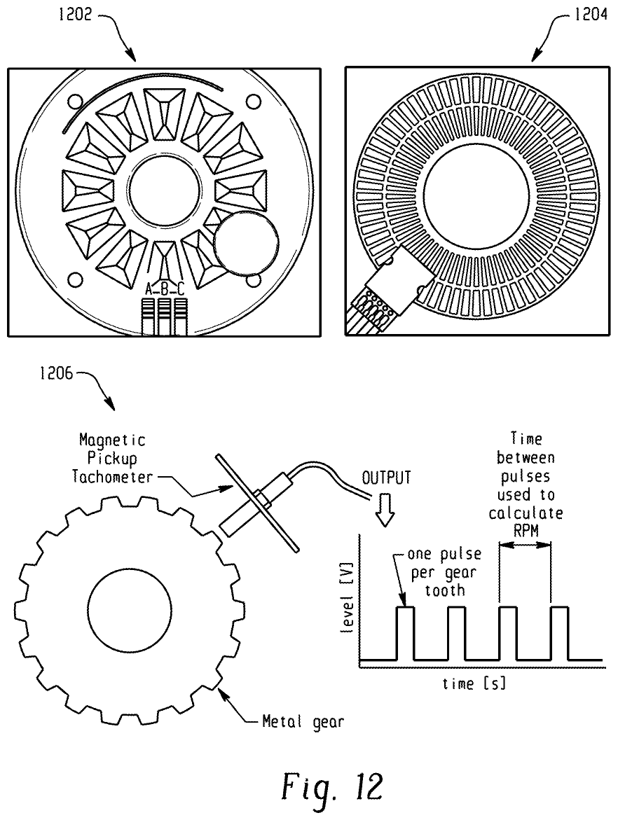

In another example, rotation of a structure, such as the lifeline hub is monitored via inductive rotation detection. FIG. 12 depicts three examples of configurations for detecting rotation via inductance. In a first example at 1202, a set of 12 inductive coils is positioned around the outside of the hub. A magnet is affixed to a structure such that it is positioned near the coils in a fixed position. As the hub and corresponding coils rotate, current induced in the coils is measured to indicate rotation direction and velocity. A similar arrangement is depicted at 1204. A further example is shown at 1206. There, a magnetic pickup tachometer is positioned facing teeth of a rotating metal gear. A voltage output from the tachometer varies based on an inducted current that is dependent on a distance of a gear structure from the tachometer, resulting in one pulse per gear tooth. A time between pulses is indicative of a speed of rotation of the corresponding metal gear. Voltage or current induced by and inductance sensor may be used as a wakeup signal for a processor or other electronics of a sensor system.

In some embodiments, inductive rotation detection can be achieved with inductive encoders. Inductive encoders comprise a set of coils that rotate with the hub and a magnet sensor. As described above, a set of coils rotate with the hub and a magnetic sensor is utilized to track changes in currents induced by the coils. The change in current is used to monitor the rotation of the hub.

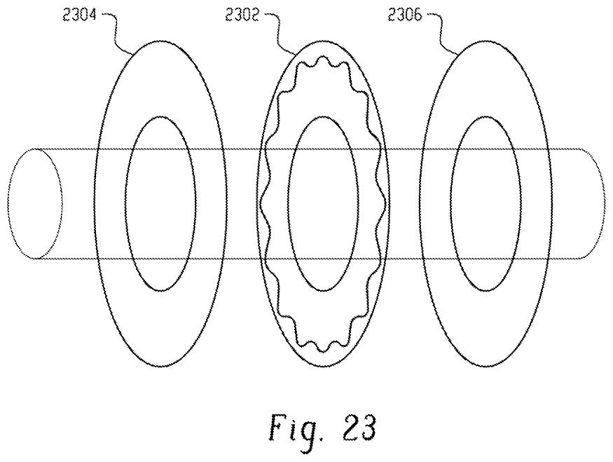

In another example, rotation of a structure, such as the lifeline hub, is monitored using a capacitive encoder. FIG. 23 shows a capacitive encoder 2300, which includes a disk 2302 with a sinusoidal pattern, a transmitter 2304 and a receiver 2306. The transmitter 2304 and the receiver 2306 are stationary. The disk 2302 rotates with the lifeline hub and the capacitive encoder 2300 is able to detect changes in the capacitance-reactance and calculate rotary motion.

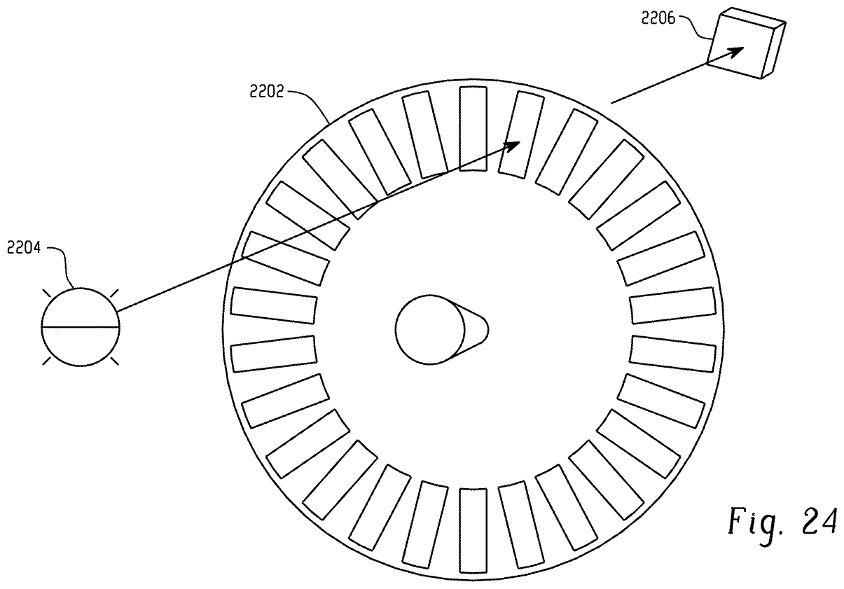

In another example, rotation of a structure, such as the lifeline hub is monitored using an optical encoder 2400 is shown in FIG. 24. The optical encoder 2400 includes a circular disc 2402, which has one or more alternating transparent and opaque areas. The circular disc 2402 also has an aperture through which a shaft that is connected to the hub around which the lifeline is wound. The circular disc 2202 would rotate when the hub rotates. The optical encoder 2402 also includes a light source 2404 and a light sensor 2406. One example of a light source 2404 is a LED. Examples of a light sensor 2406 are a photocell, phototransistor, a photodiode or a photoresistor. The light source 2404 emits a beam of light through the circular disc 2402. The light sensor 2406 senses and tracks the beam of light by outputting a signal. When the circular disc 2402 is rotating, the beam of light is interrupted by the opaque areas of the circular disc 2402 and the output signal from the light sensor generates a series of voltage pulses. These pulses can be used to calculate the number of rotations of the lifeline hub.

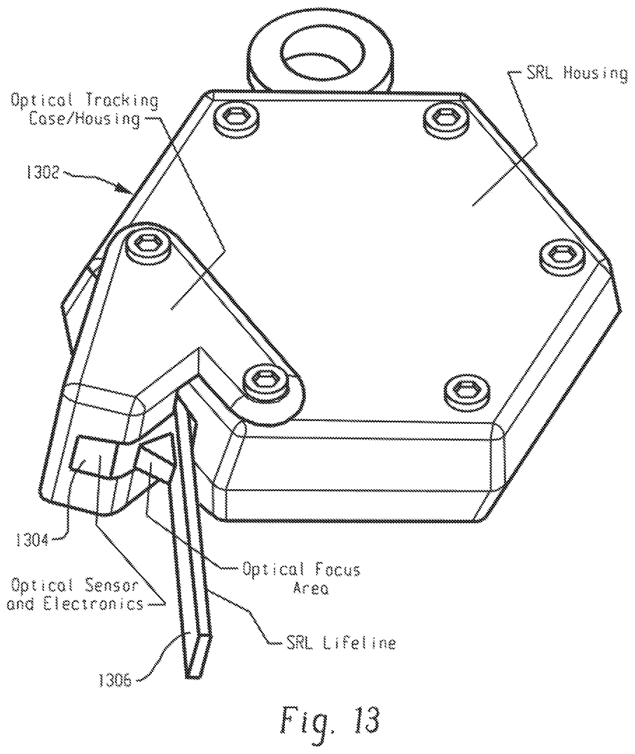

In other examples, monitoring of the lifeline can be used to determine a length of lifeline paid out or retracted from a fall limiting device. FIG. 13 depicts a fall limiting device 1302 equipped with an optical sensor 1304. There a fall limiting device in the form of a self-retracting lanyard includes an optical sensor, such as an optical sensor 1304 similar to an optical computer-mouse sensor. The optical sensor 1304 is focused on the lifeline 1304, where changes in a signal periodically received from the optical sensor (e.g., based on a natural texture of the lifeline) are indicative of an amount of movement of the lifeline 1306 over the sensing period. That detected amount of movement of the lifeline 1306 is stored as an amount of lifeline 1306 paid out from or retracted into the fall limiting device 1302.

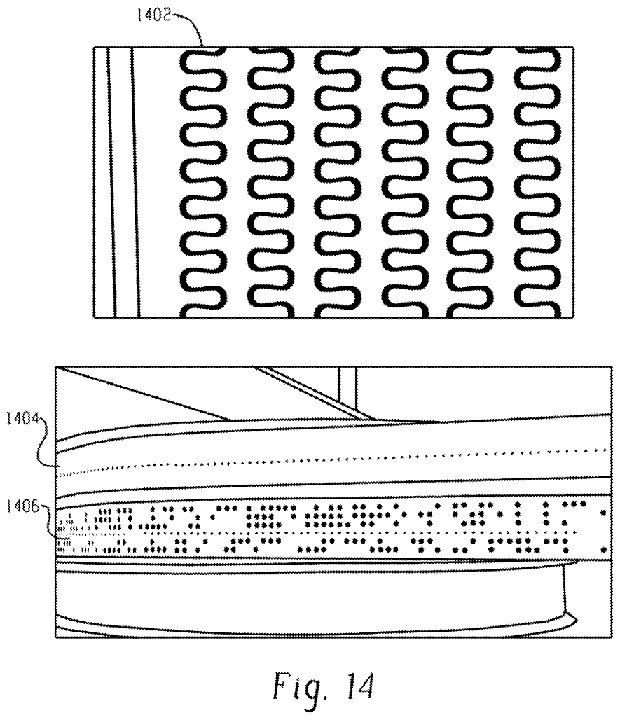

In an embodiment, the lifeline may be equipped with indica for facilitating optical or electrical monitoring. FIG. 14 depicts indicia incorporated into or onto a lifeline to facilitate monitoring of pay out or retraction. Indicia may be incorporated into a lifeline (e.g., woven into the lifeline), applied to an outside of the lifeline (e.g., painted or drawn on), or may be present on a sheath applied to an outside of the lifeline. A first lifeline is show at 1402 that depicts a periodic wave pattern present on a lifeline. The wave pattern, in one embodiment, is reflective and improves movement sensing by an optical sensor. In another example, the pattern is a metal pattern that is amenable to inducing current in a sensor to provide a signal indicative of movement of the lifeline. Alternate indica forms are provide at 1404 and 1406 in the forms of perforation patterns applied to the lifeline (e.g., via a sheath). The pattern at 1404 is periodic and designed to improve optical sensing of an amount of movement of the lifeline. The pattern at 1406 provides a code that is unique across at least a length of the lifeline, whereby an optical sensor focused on the lifeline can read the code and decipher an amount of lifeline paid out or retracted from the fall limiting device based on the determined code.

In some embodiments, the rotation of a structure, such as the lifeline hub, can be calculated using a back electromagnetic field (EMF). A back EMF uses a motor or dynamo to generate a voltage and current that represent a magnitude and direction of rotation. A sensor can detect the voltage and current. The magnitude is directly proportional to the speed of rotation of the hub.

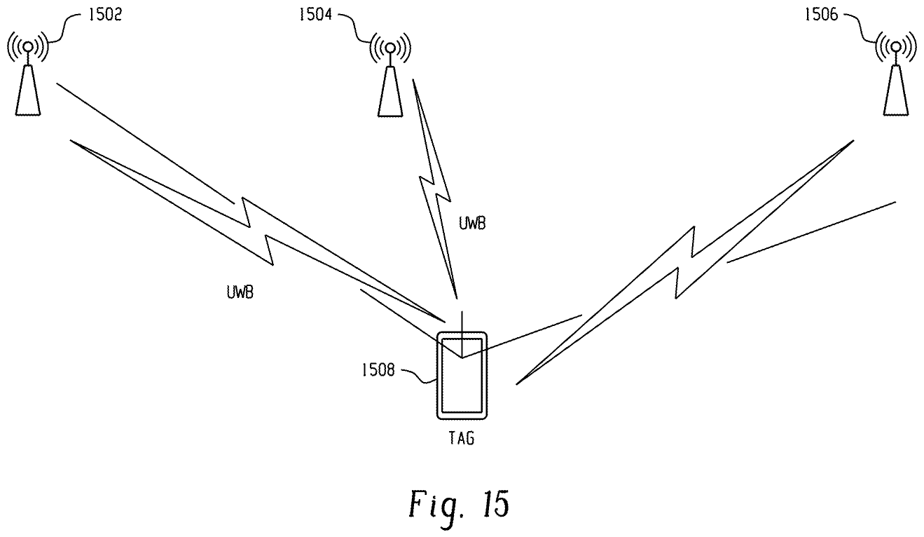

In another embodiment, an amount of lifeline paid out or retracted from a fall limiting device is determined based on periodic assessment of a location of the fall limiting device. Where a connection point of the fall limiting device to a supporting structure is fixed, location of the fall limiting device relative to that fixed position can be used to determine an amount of lifeline currently paid out from the fall limiting device. Current location of the fall limiting device can be determined by GPS onboard the fall limiting device in one example. In another example, triangulation via a tag (e.g., a UWB tag, an RFID tag) may be used to determine location. FIG. 15 is a diagram depicting triangulation of a location of a fall limiting device based on an tag affixed to the device. Signals (e.g., ultra-wide band signals) are transmitted from multiple base stations 1502, 1504, 1506 with overlapping signal fields. An tag 1508 responds to pings from the base stations 1502, 1504, 1506, where a time between signal transmission from the base stations 1502, 1504, 1506 and receipt of a return signal from the tag 1508 is used to triangulate a location of the fall limiting device. A distance from the current position of the fall limiting device to the point of connection is then used to ascertain an amount of lifeline currently paid out from the device. Periodic location determination can be used to generate a use profile for the fall limiting device. In another example, detected relative distances between a first tag positioned on a fall limiting device and a second tag positioned on a hook to which a user is connected can be used to determine a current amount of lifeline paid out from the fall limiting device.

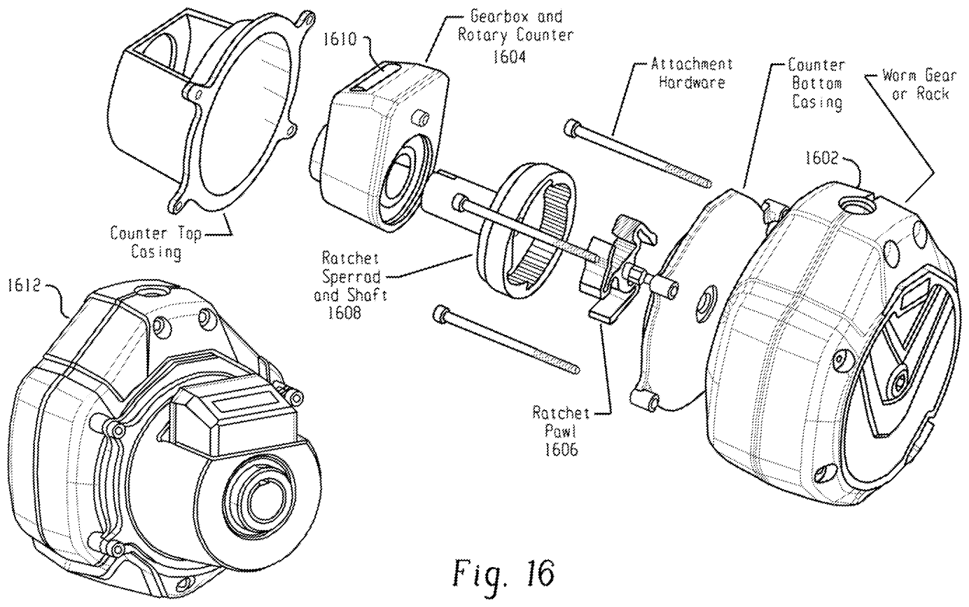

Mechanical structures may also be used to sense payout and retraction of a lifeline. FIG. 16 depicts a gearbox with a rotary counter that is incorporated into a fall limiting device. In the FIG. 16 arrangement a mechanical counter is attached to a fall limiting device such that it is responsive to rotation of a lifeline hub. Rotation of the hub within case 1602 is communicated to a rotary counter via a ratchet pawl 1606 and shaft 1608. When the mechanical counter 1604 reaches a predefined threshold, an indicator 1610 is activated (e.g., a mechanically activated popup, a colored indicator moved into a viewable position) indicating that maintenance should be performed on the fall limiting device. The fall limiting device with mechanical counter in assembled form is shown at 1612.

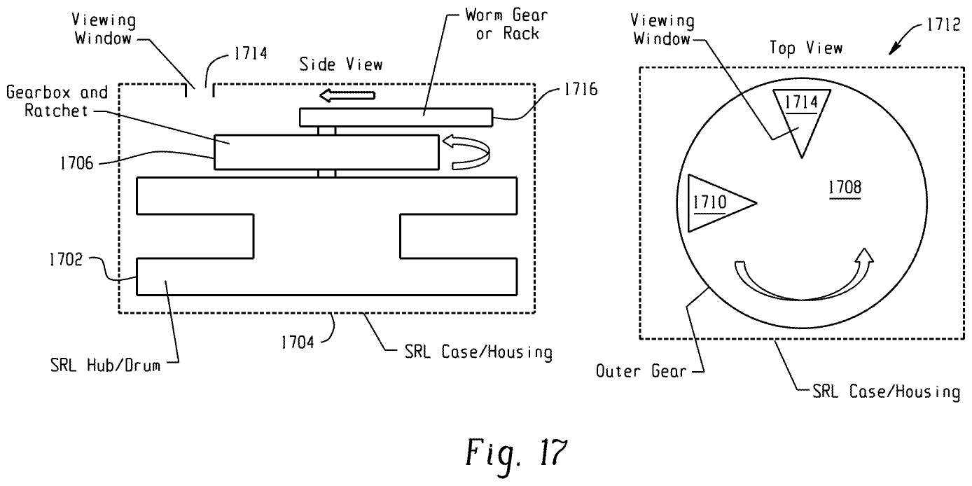

FIG. 17 depicts another mechanical apparatus for measuring an amount of lifeline paid out from a fall limiting device or a number of times that the lifeline has been paid out from the fall limiting device. In FIG. 17, rotation of a lifeline hub 1702 within a fall limiting device casing 1704 turns a gearbox and ratchet 1706. Rotation over a period of time rotates a disk 1708 having an indicator 1710 thereon via a worm gear or rack 1716. As shown at 1712, sufficient rotation of the lifeline hub 1702 will move the indicator 1710, such that it is viewable through a viewing window 1714. The appearance of the indicator 1710 in the viewing window 1714 indicates that maintenance should be performed on the fall limiting device. In one embodiment, the disk 1708 is rotated by the ratchet system based on a length of lifeline paid out from the fall limiting device. In another example, the ratchet system is configured to increment rotation the disk 1708 each time lifeline is paid out/retracted from the fall limiting device, where a change in direction of the lifeline from the fall limiting system is used as a trigger for advancing the disk 1708.

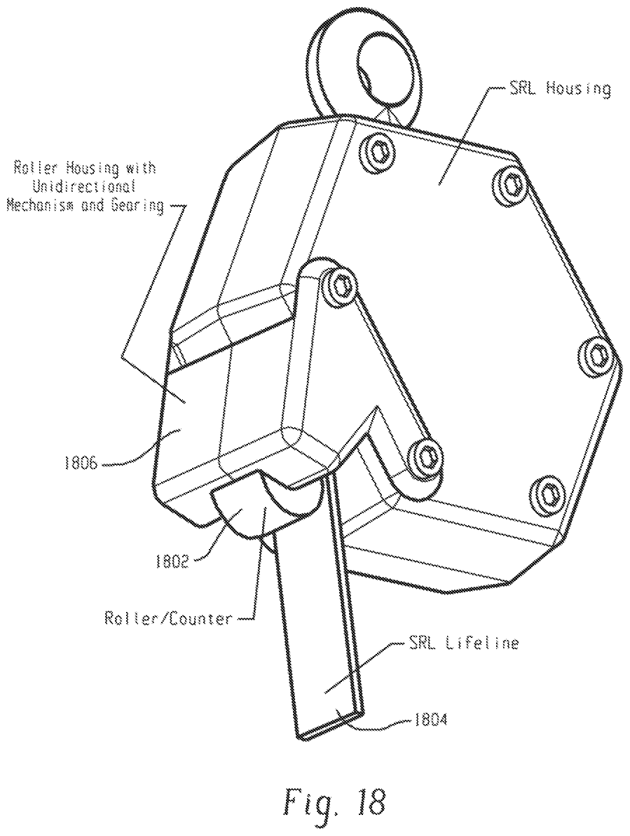

FIG. 18 depicts a further mechanical mechanism for measuring payout and retraction of a lifeline from a fall limiting device or a number of times that the lifeline has been paid out from the fall limiting device. A roller 1802 is positioned such that it is responsive (e.g., it rolls via contact with the lifeline) to the lifeline 1804. A counter 1806 is responsive to the roller 1802, where the counter is incremented based on rolling in one direction. In embodiments, rolling in an opposite direction does not increase the counter. In another embodiment, the counter is increased based on rolling in both directions. A current counter value may be made visible via a mechanical user interface or may be converted into an electrical signal for storage in a computer-readable medium. In one embodiment, the counter is incremented based on a length of lifeline paid out from the fall limiting device (e.g., once every x meters). In another example, the counter is incremented each time lifeline is paid out/retracted from the fall limiting device, where a change in direction of the lifeline from the fall limiting system is used as a trigger for advancing the counter.

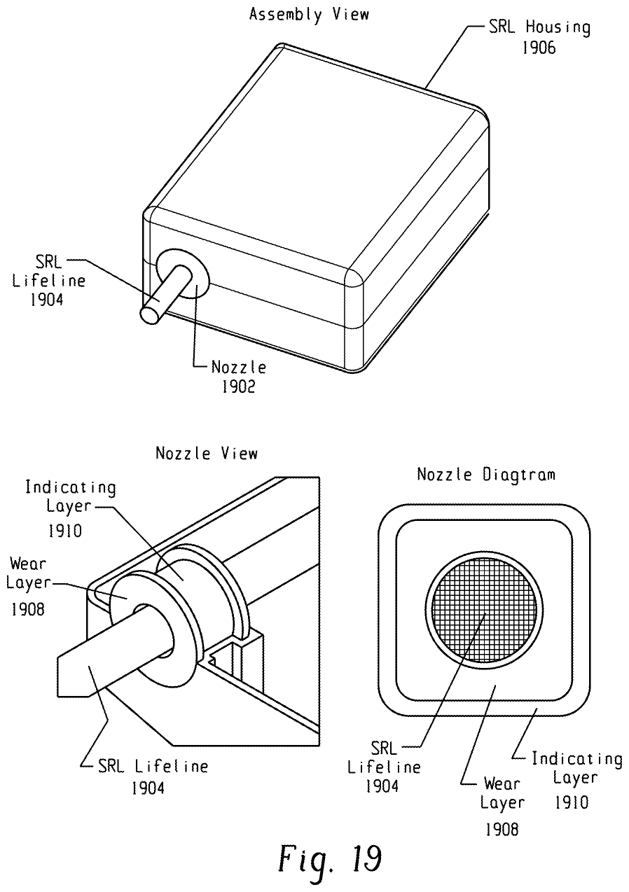

FIG. 19 provides a further mechanical mechanism for measuring lifeline payout and retraction via a sacrificial nozzle. In FIG. 19, a nozzle 1902 is positioned at a lifeline 1904 output point of a fall limiting device 1906. An inner portion 1908 of the nozzle 1902 has a first color (e.g., gray) while an outer portion 1910 has a second color (e.g., red). Passage of the lifeline 1904 through the nozzle wears away the nozzle over time. Sufficient wear will make the outer portion 1910 and its corresponding color (e.g., red) visible, indicating that maintenance should be performed on the fall limiting device.

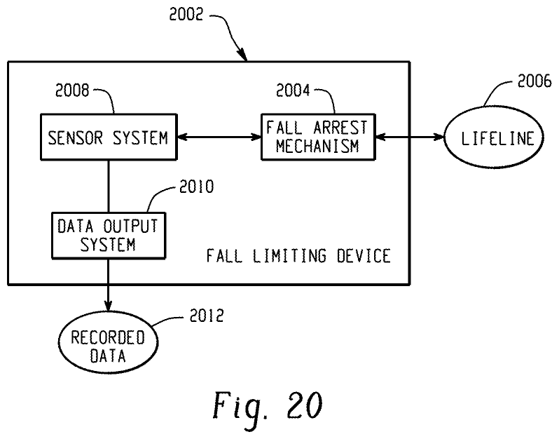

FIG. 20 is a diagram depicting an example fall limiting device. A fall limiting device 2002 may include a fall arrest mechanism 2004 configured to control a lifeline 2006 extending therefrom, said control comprising one or more of: paying out the lifeline, retracting the lifeline, and apply a braking force to the lifeline during a fall arrest condition. A sensor system 2008 is configured to monitor one or more aspects of said control of the lifeline 2006 and to record data on a non-transitory computer-readable medium. A data output system 2010 is configured to provide access to the recorded data 2012.

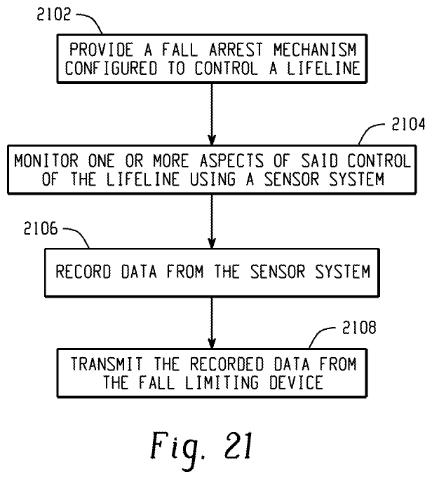

FIG. 21 is a flow diagram depicting a method of operating a fall limiting device. At 2102, a fall arrest mechanism is provided that is configured to control a lifeline extending therefrom, said control comprising one or more of: paying out the lifeline, retracting the lifeline, and apply a braking force to the lifeline during a fall arrest condition. One or more aspects of said control of the lifeline are monitored using a sensor system at 2104. Data from the sensor system is recorded on a non-transitory computer-readable medium at 2106, and at 2108, the recorded data is transmitted from the fall limiting device.

The following are additional embodiments of a fall limiting device. In one embodiment, the fall limiting device may comprise a fall arrest mechanism configured to control a lifeline extending therefrom, said control comprising one or more of paying out the lifeline, retracting the lifeline, and brake events indicating a fall arrest condition, a sensor system configured to monitor one or more aspects of said control of the lifeline and to record data on a non-transitory computer readable medium, and a data output system configured to provide access to the recorded data.

In some embodiments, the recorded data comprises a length of the lifeline that has been paid out of the fall arrest mechanism over a period of time.

In some embodiments, the period of time is a lifetime of the device, an amount of time since a last maintenance of the device or an amount of time since a last data output of recorded data.

In some embodiments, maintenance or retirement decisions regarding the fall limiting device are made based on recorded data.

In some embodiments, the sensor system is configured to monitor rotation of a gear or a drum around which the lifeline is wound.

In some embodiments, the gear is a retraction dampener gear configured to slow said retracting of the lifeline.

In some embodiments, the monitored rotation is converted into a distance of the lifeline paid out from the fall arrest mechanism.

In some embodiments, the sensor system comprises a rotary encoder that outputs a signal based on a change of position of the gear or drum with which the rotary encoder is interfaced.

In some embodiments, the sensor system comprises a magnetometer that detects relative variances of the gear, drum, a wire coil, or magnets associated with the gear or drum during movement of the gear or drum.

In some embodiments, the fall limiting device also comprises a counter that is configured to be incremented mechanically based on the rotation of the fear or drum or electronically incremented based on optical or electrical monitoring of rotation of the gear or drum.

In some embodiments, the optical monitoring of the rotation of the gear or drum is based on detection of gear teeth passing by a sensor or based on a visual indicator present on the gear or drum.

In some embodiments, the data output system is a wireless data output system that transmits recorded data while the fall limiting device is being used.

In some embodiments, the data output system is configured to transmit a signal when the fall arrest condition is detected.

In some embodiments, the fall arrest condition signal requests help or signals that the device should be inspected before further use.

In some embodiments, the data output system is a wireless data output system that transmits recorded data using near field communication when a command is received, periodically, or after the conclusion of use of the fall limiting device.

In some embodiments, the recorded data is transmitted to a mobile device.

In some embodiments, the data output system is configured to output recorded data via a wired connection.

In some embodiments, the sensor system outputs an identifier associated with the sensor system.

In some embodiments, the sensor system is configured to optically monitor the lifeline to determine a length of the lifeline that has been paid out of the fall arrest mechanism.

In some embodiments, the optical monitoring is based on a natural texture of the lifeline, a repeating pattern on the lifeline, markings applied along a length of the lifeline that are unique at least along said length.

In some embodiments, the sensor system is configured to monitor a signal reflected from the lifeline that is augmented by varying reflective indicia on or in the lifeline.

In some embodiments, the identifier of the sensor system is associated with an identifier of the fall arrest mechanism via scanning of an RFID associated with the sensor system and an RFID associated with the fall arrest mechanism using a mobile device.

In some embodiments, the fall limiting device also includes a recharging module and a battery, wherein the recharging module is configured to harvest energy from the paying out or retracting of the lifeline to recharge the battery, wherein the sensor system is powered via the battery.

In some embodiments, the recharging module includes a DC motor.

In some embodiments, a back EMF signal generated by the DC motor is used to determine payout or retraction of the lifeline.

In some embodiments, the fall arrest mechanism is contained within a rollable, protective shell that comprises a case, a first contact surface ring encompassing the case, and a second contact surface ring encompassing the case.

In some embodiments, the first and second contact surface rings are positioned so as to enable access to a control associated with the sensor system.

In some embodiments, the sensor system comprises a tag attached to a connector at the end of the lifeline, wherein a location of the tag is triangulated based on one or more wireless base stations, wherein payout of the line is determined based on the location of the tag and a location of the fall arrest mechanism.

In some embodiments, the fall limiting device further includes a maintenance indicator configured to display an indication of whether the fall limiting device is in a maintenance-needed state based on the recorded data.

In some embodiments, the fall limiting device further includes a locking mechanism, wherein the locking mechanism is configured to prevent use of the fall limiting device based on the recorded data.

In some embodiments, the locking mechanism prevents use of the fall limiting device when maintenance is required or when the fall limiting device should be retired.

In some embodiments, the fall limiting device is configured to wirelessly receive a signal and to limit operation of the fall limiting device based on that signal.

In some embodiments, the fall limiting device is configured to lock out usage until maintenance is performed based on the received signal.

In some embodiments, the fall limiting device is configured to lock out usage while the fall limiting device is in an area that is identified as being inappropriate for its use based on the received signal.

In some embodiments, the fall arrest mechanism is configured to limit a length of lifeline that can be paid out at one time based on the received signal.

An embodiment for a method operating a fall limiting device may comprise providing a fall arrest mechanism configured to control a lifeline extending therefrom, said control comprising one or more of: paying out the lifeline, retracting the lifeline, and brake events indicating a fall arrest condition, monitoring one or more aspects of said control of the lifeline using a sensor system, recording data from the sensor system on a non-transitory computer-readable medium; and, transmitting the recorded data from the fall limiting device.

Another embodiment of a fall limiting device includes a fall arrest mechanism configured to control a lifeline extending therefrom, said control comprising one or more of: paying out the lifeline, retracting the lifeline, and applying a braking force to the lifeline during a fall arrest condition, a sensor system configured to monitor one or more aspects of said control of the lifeline.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

It is claimed:

1. A fall limiting device, comprising:
a fall arrest mechanism configured to control a lifeline extending therefrom, said control comprising one or more of: paying out the lifeline, retracting the lifeline, and brake events indicating a fall arrest condition;
a sensor system configured to monitor one or more aspects of said control of the lifeline and to record data on a non-transitory computer-readable medium; and
a data output system configured to provide access to the recorded data.

2. The device of claim 1, wherein the recorded data comprises a length of the lifeline that has been paid out of the fall arrest mechanism over a period of time.

3. The device of claim 1, wherein maintenance or retirement decisions regarding the fall limiting device are made based on the recorded data.

4. The device of claim 1, wherein the sensor system is configured to monitor rotation of a gear or a drum around which the lifeline is wound.

5. The device of claim 4, wherein the sensor system comprises a rotary encoder that outputs a signal based on a change of position of the gear or drum with which the rotary encoder is interfaced.

6. The device of claim 4, wherein the sensor system comprises a magnetometer that detects relative variances of the gear, drum, a wire coil, or magnets associated with the gear or drum during movement of the gear or drum.

7. The device of claim 4, further comprising a counter that is configured to be incremented mechanically based on rotation of the gear or drum or electronically incremented based on optical or electrical monitoring of rotation of the gear or drum.

8. The device of claim 1, wherein the data output system is a wireless data output system that transmits recorded data while the fall limiting device is being used.

9. The device of claim 1, wherein the sensor system further outputs an identifier associated with the sensor system.

10. The device of claim 1, further comprising a recharging module and a battery;
wherein the recharging module is configured to harvest energy from at least one of the paying out or retracting of the lifeline or via solar power to recharge the battery, wherein the sensor system is powered via the battery.

11. The device of claim 1, wherein the fall arrest mechanism is contained within a rollable, protective shell that comprises a case, a first contact surface ring encompassing the case, and a second contact surface ring encompassing the case.

12. The device of claim 11, wherein the first and second contact surface rings are positioned so as to enable access to a control associated with the sensor system.

13. The device of claim 1, further comprising a maintenance indicator configured to display an indication of whether the fall limiting device is in a maintenance-needed state based on the recorded data.

14. The device of claim 1, further comprising a locking mechanism, wherein the locking mechanism is configured to prevent use of the fall limiting device based on the recorded data.

15. The device of claim 14, wherein the locking mechanism prevents use of the fall limiting device when maintenance is required or when the fall limiting device should be retired.

16. The device of claim 1, wherein the fall limiting device is configured to wirelessly receive a signal and to limit operation of the fall limiting device based on that signal.

17. The device of claim 16, wherein the fall arrest mechanism is configured to limit a length of lifeline that can be paid out at one time based on the received signal.

18. A method of operating a fall limiting device, comprising:
providing a fall arrest mechanism configured to control a lifeline extending therefrom, said control comprising one or more of: paying out the lifeline, retracting the lifeline, and brake events indicating a fall arrest condition;
monitoring one or more aspects of said control of the lifeline using a sensor system;
recording data from the sensor system on a non-transitory computer-readable medium; and
transmitting the recorded data from the fall limiting device.

19. A fall limiting device, comprising:
a fall arrest mechanism configured to control a lifeline extending therefrom, said control comprising one or more of: paying out the lifeline, retracting the lifeline, and applying a braking force to the lifeline during a fall arrest condition;
a sensor system configured to monitor one or more aspects of said control of the lifeline.
